(19) United States
(12) Patent Application Publication
(10) Pub. No.: US 2025/0179244 A1
(43) Pub. Date: Jun. 5, 2025

(54) POLYCARBONATE RESIN AND MOLDED PRODUCT CONTAINING SAME

(71) Applicants: FUJIFILM Corporation, Tokyo (JP); FUJIFILM Wako Pure Chemical Corporation, Osaka (JP)

(72) Inventors: Shohei KATAOKA, Kanagawa (JP); Kazuhiro HAMADA, Kanagawa (JP)

(73) Assignees: FUJIFILM Corporation, Tokyo (JP); FUJIFILM Wako Pure Chemical Corporation, Osaka (JP)

(21) Appl. No.: 19/050,125

(22) Filed: Feb. 11, 2025

Related U.S. Application Data
(63) Continuation of application No. PCT/JP2023/034754, filed on Sep. 25, 2023.

(30) Foreign Application Priority Data
Sep. 30, 2022 (JP) 2022-157798

(51) Int. Cl. C08G 64/06; B29C 45/00; B29K 69/00

(52) U.S. Cl. CPC C08G 64/06; B29C 45/0001; B29K 2069/00

(57) ABSTRACT

Provided are a polycarbonate resin containing structural units (A) to (C) represented by Formulae (A) to (C), in which a proportion of (A): (B): (C) is 25 to 45 mol %:25 to 45 mol %:15 to 50 mol %; and a molded product containing the same.

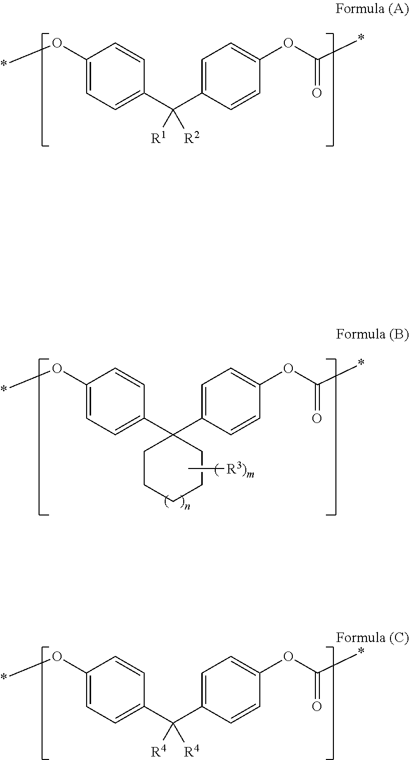

In the formulae, R¹ represents a C6 or more aliphatic hydrocarbon group and R² represents a hydrogen atom or a substituent. R³ represents a substituent. n is an integer of 0 to 8 and m is an integer of 4+n or less. R⁴ represents a hydrogen atom or a C1 to C5 aliphatic hydrocarbon group. Here, R¹ and R², or R⁴'s are not bonded to each other to form a ring. * represents a bonding site.

A 1,4-phenylene group in the formulae may be substituted with an aliphatic hydrocarbon group and/or an aromatic hydrocarbon group.

### CROSS-REFERENCE TO RELATED APPLICATIONS

This application is a Continuation of PCT International Application No. PCT/JP2023/034754 filed on Sep. 25, 2023, which claims priority under 35 U.S.C. § 119 (a) to Japanese Patent Application No. 2022-157798 filed in Japan on Sep. 30, 2022. Each of the above applications is hereby expressly incorporated by reference, in its entirety, into the present application.

### BACKGROUND OF THE INVENTION

### 1. Field of the Invention

The present invention relates to a polycarbonate resin and a molded product containing the same.

### 2. Description of the Related Art

Since a polycarbonate resin is excellent in transparency, impact resistance, heat resistance, dimensional stability, flame retardance, and the like, the polycarbonate resin is widely used as a component of electronics, electricity, machinery, automobiles, and the like.

Research on polycarbonate having a specific chemical structure has been conducted on these applications.

For example, JP2005-263886A discloses an aromatic polycarbonate copolymer substantially composed of a cyclohexane ring-containing dihydric phenol component (A) such as 1,1-bis (4-hydroxyphenyl)-3,3,5-trimethylcyclohexane and a dihydric phenol component (B) having an alkyl group having a specific number of carbon atoms, such as 1,1-bis (4-hydroxyphenyl) decane, in which a molar ratio of the (A) component to the (B) component is (A):(B)=30:70 to 80:20.

WO2017/099226A discloses a polycarbonate resin composition for a thin optical component, which contains, with respect to 100 parts by mass of an aromatic polycarbonate resin (A) having a viscosity-average molecular weight of 10,000 to 15,000, 2 to 100 parts by mass of an aromatic polycarbonate copolymer (B) consisting of a carbonate structural unit (i) derived from a bisphenol component having an alkyl group or an alkenyl group having 8 to 24 carbon atoms and a carbonate structural unit (ii) derived from bisphenol A, in which a proportion of the carbonate structural unit (i) with respect to a total 100 mol % of the carbonate structural unit (i) and the carbonate structural unit (ii) in the aromatic polycarbonate copolymer (B) is more than 10 mol % and less than 39 mol %.

In addition, WO2007/119548A discloses a polycarbonate resin including a constitutional unit derived from a bisphenol component having a long-chain unsaturated hydrocarbon group having a double bond, and discloses that an electrophotographic photosensitive body having favorable abrasion resistance and image stability in a high-temperature and high-humidity environment is obtained using the polycarbonate resin as an electrophotographic photosensitive binder resin.

### SUMMARY OF THE INVENTION

However, according to the research of the present inventors, it has been found that the polycarbonate resin or the resin composition in the related art, such as the polycarbonate resin disclosed in JP2005-263886A or WO2007/119548A and the polycarbonate resin composition for a thin optical component disclosed in WO2017/099226A described above, has not achieved realization of characteristics of exhibiting a sufficiently high impact resistance in addition to a high glass transition temperature (hereinafter, the glass transition temperature is also referred to as “Tg”) and low water absorbency.

That is, in the aromatic polycarbonate copolymer disclosed in JP2005-263886A, high Tg is exhibited by the cyclohexane ring-containing dihydric phenol component (A), low water absorbency is exhibited by the dihydric phenol component (B) having a long-chain alkyl group, and both high Tg and low water absorbency are achieved by adjusting a molar ratio of the two copolymerization components to a specific range. However, blending of the cyclohexane ring-containing dihydric phenol component (A) causes restriction on improvement of the impact strength.

In addition, Examples of WO2017/099226A merely show that the resin composition obtained by using, in combination, the aromatic polycarbonate copolymer consisting of a carbonate structural unit (i) having a long-chain alkyl group which contributes to improvement of the impact strength (low Tg) and a carbonate structural unit (ii) derived from bisphenol A with the polycarbonate homopolymer (having a viscosity-average molecular weight of 10,000 to 15,000) in which bisphenol A is used as a starting raw material, exhibits the same fluidity as the polycarbonate homopolymer in which bisphenol A is used as a starting raw material, while the impact strength is improved. In other words, in the polycarbonate resin composition for a thin optical component disclosed in WO2017/099226A, a decrease in Tg occurs due to the carbonate structural unit (i) having a long-chain alkyl group, and both high Tg and impact resistance cannot be achieved.

In addition, in WO2007/119548A, high Tg, low water absorbency, and impact resistance are not disclosed or suggested at all, and as will be described later, it is considered that the polycarbonate disclosed in Examples of WO2007/119548A cannot achieve both high Tg, low water absorbency, and impact resistance (see a comparative polycarbonate c08 described in the section of Examples in the present specification).

An object of the present invention is to provide a polycarbonate resin which exhibits a high Tg (100° C. or higher) and low water absorbency (water absorption rate of less than 0.30% by mass) and further has excellent impact resistance; and to provide a molded product containing the polycarbonate resin.

The above-described objects of the present invention have been achieved by the following methods.

<1>

A polycarbonate resin comprising:

a structural unit (A) represented by General Formula (A);

a structural unit (B) represented by General Formula (B); and

a structural unit (C) represented by General Formula (C),

in which, with respect to a total of 100 mol % of the structural units (A), (B), and (C), a proportion of the structural unit (A) is 25 to 45 mol %, a proportion of the structural unit (B) is 25 to 45 mol %, and a proportion of the structural unit (C) is 15 to 50 mol %,

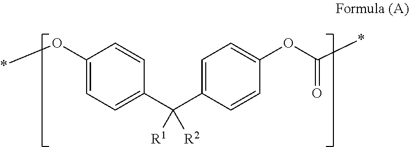

in the formula, R¹ represents an aliphatic hydrocarbon group having 6 or more carbon atoms, and R² represents a hydrogen atom, an aliphatic hydrocarbon group, or an aromatic hydrocarbon group, provided that R¹ and R² are not bonded to each other to form a ring, and * represents a bonding site,

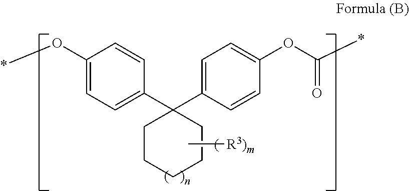

in the formula, R³ represents an aliphatic hydrocarbon group, n is an integer of 0 to 8, m is an integer of 4+n or less, and * represents a bonding site,

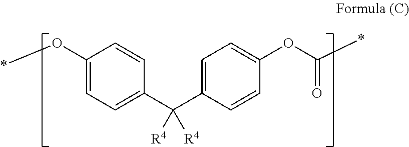

in the formula, R⁴ represents a hydrogen atom or an aliphatic hydrocarbon group having 1 to 5 carbon atoms, provided that R⁴'s are not bonded to each other to form a ring, and * represents a bonding site,

a 1,4-phenylene group in General Formulae (A) to (C) may have an aliphatic hydrocarbon group and/or an aromatic hydrocarbon group as a substituent.

<2>

The polycarbonate resin according to <1>,

in which the proportion of the structural unit (A) is 30 to 45 mol %.

<3>

The polycarbonate resin according to <1>or <2>,

in which the proportion of the structural unit (B) is 25 to 40 mol %.

<4>

The polycarbonate resin according to any one of <1>to <3>,

in which, in General Formula (C), at least one of R⁴'s is an aliphatic hydrocarbon group having 2 to 5 carbon atoms.

<5>

The polycarbonate resin according to any one of <1>to <4>,

in which, in General Formula (A), R¹ has no branched structure.

<6>

A molded product comprising:

the polycarbonate resin according to any one of <1>to <5>.

In the present invention, in a case of a plurality of substituents, linking groups, and the like (hereinafter, referred to as a substituent and the like) represented by a specific reference or formula, or in a case of simultaneously defining a plurality of the substituent and the like, unless otherwise specified, the substituent and the like may be the same or different from each other (regardless of the presence or absence of an expression “each independently”, the substituent and the like may be the same or different from each other). The same applies to the definition of the number of substituents and the like. In addition, in the present invention, in a case where there are a plurality of structural units represented by a specific formula, the plurality of structural units may be the same or different from each other (regardless of whether or not the expression “each independently” is used, the plurality of structural units may be the same or different from each other) unless otherwise specified. In a case where a plurality of substituents and the like are near (particularly, adjacent to each other), unless otherwise specified, the substituents and the like may be linked to each other to form a ring. In addition, unless otherwise specified, a ring, for example, an alicyclic ring, an aromatic ring, or a heterocyclic ring may be further condensed to form a fused ring.

In the present invention, unless otherwise specified, with regard to a double bond, in a case where E-form and Z-form are present in the molecule, the double bond may be any one of these forms, or may be a mixture thereof.

In addition, in the present invention, unless otherwise specified, in a case where a compound has one or two or more asymmetric carbons, for such stereochemistry of asymmetric carbons, either an (R)-form or an (S)-form can be independently taken. As a result, the compound may be a mixture of optical isomers or stereoisomers such as diastereoisomers, or may be racemic.

In addition, in the present invention, the expression of the compound means that a compound having a partially changed structure is included within a range which does not impair the effects of the present invention. Furthermore, a compound which is not specifically described as substituted or unsubstituted may have an optional substituent within a range which does not impair the effects of the present invention.

In the present invention, in a case where the number of carbon atoms in a certain group is specified, the number of carbon atoms means the number of carbon atoms in the entire group, unless otherwise specified in the present invention or the present specification. The number of carbon atoms may be denoted by C; and for example, the number of carbon atoms of 6 or more may be denoted by C6 or more, and the number of carbon atoms of 1 to 5 may be denoted by C1 to C5.

In the present invention, a numerical range represented by using “to” means a range including numerical values described before and after “to” as a lower limit value and an upper limit value.

In the present invention, an aliphatic hydrocarbon group is a monovalent group obtained by removing one optional hydrogen atom from an aliphatic hydrocarbon, and is preferably a monovalent group obtained by removing one optional hydrogen atom from an alkane, an alkene, an alkyne, a cycloalkane, a cycloalkene, or a cycloalkyne, which is an aliphatic hydrocarbon. The aliphatic hydrocarbon group may be linear or branched, and may have a ring structure. That is, preferred examples of the aliphatic hydrocarbon group include an alkyl group, an alkenyl group, an alkynyl group, a cycloalkyl group, a cycloalkenyl group, and a cycloalkynyl group.

In the present invention, the number of carbon atoms in an alkyl group is preferably 1 to 24, more preferably 1 to 20, still more preferably 1 to 12, particularly preferably 1 to 6, and most preferably 1 to 4.

Examples of a linear alkyl group include a methyl group, an ethyl group, an n-propyl group, an n-butyl group, an n-pentyl group, an n-hexyl group, an n-heptyl group, an n-octyl group, an n-nonyl group, an n-decyl group, an n-undecyl group, an n-dodecyl group, an n-tridecyl group, an n-tetradecyl group, an n-pentadecyl group, an n-hexadecyl group, an n-heptadecyl group, an n-octadecyl group, an n-nonadecyl group, an n-eicosyl group, an n-heneicosyl group, an n-docosyl group, an n-tricosyl group, and an n-tetracosyl group.

Examples of a branched alkyl group include a methylethyl group, a methylpropyl group, a methylbutyl group, a methylpentyl group, a methylhexyl group, a methylheptyl group, a methyloctyl group, a methylnonyl group, a methyldecyl group, a methylundecyl group, a methyldodecyl group, a methyltridecyl group, a methyltetradecyl group, a methylpentadecyl group, a methylhexadecyl group, a methylheptadecyl group, a methyloctadecyl group, a methylnonadecyl group, a methylicosyl group, a methylhenicosyl group, a methyldocosyl group, a methyltricosyl group,

a dimethylethyl group, a dimethylpropyl group, a dimethylbutyl group, a dimethylpentyl group, a dimethylhexyl group, a dimethylheptyl group, a dimethyloctyl group, a dimethylnonyl group, a dimethyldecyl group, a dimethylundecyl group, a dimethyldodecyl group, a dimethyltridecyl group, a dimethyltetradecyl group, a dimethylpentadecyl group, a dimethylhexadecyl group, a dimethylheptadecyl group, a dimethyloctadecyl group, a dimethylnonadecyl group, a dimethylicosyl group, a dimethylhenicosyl group, a dimethyldocosyl group,

a trimethylethyl group, a trimethylpropyl group, a trimethylbutyl group, a trimethylpentyl group, a trimethylhexyl group, a trimethylheptyl group, a trimethyloctyl group, a trimethylnonyl group, a trimethyldecyl group, a trimethylundecyl group, a trimethyldodecyl group, a trimethyltridecyl group, a trimethyltetradecyl group, a trimethylpentadecyl group, a trimethylhexadecyl group, a trimethylheptadecyl group, a trimethyloctadecyl group, a trimethylnonadecyl group, a trimethylicosyl group, a trimethylheneicosyl group,

an ethylethyl group, an ethylpropyl group, an ethylbutyl group, an ethylpentyl group, an ethylhexyl group, an ethylheptyl group, an ethyloctyl group, an ethylnonyl group, an ethyldecyl group, an ethylundecyl group, an ethyldodecyl group, an ethyltridecyl group, an ethyltetradecyl group, an ethylpentadecyl group, an ethylhexadecyl group, an ethylheptadecyl group, an ethyloctadecyl group, an ethylnonadecyl group, an ethylicosyl group, an ethylhenicosyl group, an ethyldocosyl group,

a propylpropyl group, a propylbutyl group, a propylpentyl group, a propylhexyl group, a propylheptyl group, a propyloctyl group, a propylnonyl group, a propyldecyl group, a propylundecyl group, a propyl dodecyl group, a propyltridecyl group, a propyltetradecyl group, a propylpentadecyl group, a propylhexadecyl group, a propylheptadecyl group, a propyloctadecyl group, a propylnonadecyl group, a propylicosyl group, a propylhexacosyl group,

a butylbutyl group, a butylpentyl group, a butylhexyl group, a butylheptyl group, a butyloctyl group, a butylnonyl group, a butyldecyl group, a butylundecyl group, a butyldodecyl group, a butyltetradecyl group, a butylpentadecyl group, a butylhexadecyl group, a butylheptadecyl group, a butyloctadecyl group, a butylnonadecyl group, and a butyleicosyl group.

In the examples of branched alkyl groups, a position of the branch is optional.

In the present invention, the number of carbon atoms in an alkenyl group is preferably 2 to 24, more preferably 2 to 20, still more preferably 2 to 12, and particularly preferably 2 to 6.

Examples of the alkenyl group include a vinyl group, a propenyl group, a butenyl group, a pentenyl group, a hexenyl group, a heptenyl group, an octenyl group, a nonenyl group, a decenyl group, an undecenyl group, a dodecenyl group, a tridecenyl group, a tetradecenyl group, a pentadecenyl group, a hexadecenyl group, a heptadecenyl group, an octadecenyl group, a nonadecenyl group, an icosanyl group, a henicosanyl group, a docosanyl group, a tricosanyl group, a tetracosanyl group, and a 4,8,12-trimethyltridecyl group.

In the present invention, the number of carbon atoms in an alkynyl group is preferably 2 to 24, more preferably 2 to 20, still more preferably 2 to 12, and particularly preferably 2 to 6.

Examples of the alkynyl group include an ethynyl group and a propynyl group.

In the present invention, a cycloalkyl group is a monovalent group obtained by removing one optional hydrogen atom from a cycloalkane. The cycloalkyl group is preferably a cycloalkyl group having 3 to 24 carbon atoms, and examples thereof include a cyclobutyl group, a cyclopentyl group, and a cyclohexyl group.

In the present invention, a cycloalkenyl group is a monovalent group obtained by removing one optional hydrogen atom from a cycloalkene. The cycloalkenyl group is preferably a cycloalkenyl group having 5 to 24 carbon atoms, and examples thereof include a cyclopentenyl group and a cyclohexenyl group.

In the present invention, a cycloalkynyl group is a monovalent group obtained by removing one optional hydrogen atom from a cycloalkyne. The cycloalkynyl group is preferably a cycloalkynyl group having 8 to 24 carbon atoms, and examples thereof include a cyclooctynyl group.

In the present invention, an aromatic hydrocarbon group is a monovalent group obtained by removing one optional hydrogen atom from an aromatic hydrocarbon. The number of carbon atoms in the aromatic hydrocarbon group is preferably 6 to 24, more preferably 6 to 20, and still more preferably 6 to 14. Examples of the aromatic hydrocarbon group include a phenyl group, a 1-naphthyl group, a 2-naphthyl group, a 1-anthracenyl group, a 2-anthracenyl group, a 9-anthracenyl group, a 1-phenanthryl group, a 2-phenanthryl group, a 3-phenanthryl group, a 4-phenanthryl group, and a 9-phenanthryl group. Among these, a phenyl group is preferable.

The polycarbonate resin according to the aspect of the present invention exhibits a high Tg and low water absorbency, and further has excellent impact resistance. In addition, the molded product according to the aspect of the present invention contains the polycarbonate resin, has low water absorbency, has excellent heat resistance, and has excellent impact resistance.

### DESCRIPTION OF THE PREFERRED EMBODIMENTS

### Polycarbonate Resin

The polycarbonate resin according to the embodiment of the present invention is a polycarbonate resin containing a structural unit (A) represented by General Formula (A) described later, a structural unit (B) represented by General Formula (B) described later, and a structural unit (C) represented by General Formula (C) described later. In the polycarbonate resin according to the embodiment of the present invention, a proportion of each structural unit with respect to a total of 100 mol % of the above-described structural units (A), (B), and (C) is such that the above-described structural unit (A) is 25 to 45 mol %, the above-described structural unit (B) is 25 to 45 mol %, and the above-described structural unit (C) is 15 to 50 mol %. The polycarbonate resin according to the embodiment of the present invention having such a configuration exhibits a high Tg and low water absorbency, and can further sufficiently improve impact resistance. The reason for this is not clear, but is assumed as follows.

Since the polycarbonate resin according to the embodiment of the present invention contains a specific amount of the structural unit (A) having an aliphatic hydrocarbon group having 6 or more carbon atoms and a specific amount of the structural unit (B) having a 5- to 13-membered (5 +n-membered, where n is an integer of 0 to 8) ring structure, low water absorbency by the structural unit (A) and high Tg by the structural unit (B) are exhibited. Furthermore, by containing a specific amount of the structural unit (C) having a Tg higher than the structural unit (A) and lower than the structural unit (B) due to the structure, it is possible to achieve all of low water absorbency and impact resistance at a high level while maintaining a high Tg as the polycarbonate resin.

The polycarbonate resin according to the embodiment of the present invention can be suitably used, for example, as a low dielectric material due to its low water absorbency.

The polycarbonate resin according to the embodiment of the present invention may be composed of a polycarbonate containing the structural units (A) to (C) described later at the specific proportions (hereinafter, referred to as “polycarbonate according to the embodiment of the present invention”), or may be in a form of a composition in which an additive described later is blended with the polycarbonate according to the embodiment of the present invention.

Hereinafter, the polycarbonate according to the embodiment of the present invention will be described in detail.

### Polycarbonate

Structural unit (A)

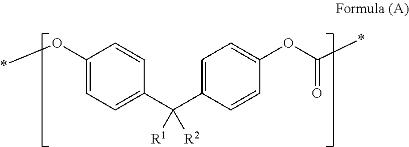

In the formula, R¹ represents an aliphatic hydrocarbon group having 6 or more carbon atoms, and R² represents a hydrogen atom, an aliphatic hydrocarbon group, or an aromatic hydrocarbon group, provided that R¹ and R² are not bonded to each other to form a ring, and * represents a bonding site.

The aliphatic hydrocarbon group having 6 or more carbon atoms as R¹ is not particularly limited as long as it has 6 or more carbon atoms, and any of aliphatic hydrocarbon groups having 6 or more carbon atoms among the above-described aliphatic hydrocarbon groups can be applied.

It is preferable that the aliphatic hydrocarbon group having 6 or more carbon atoms as R¹ does not include a ring structure. From the viewpoint of further increasing Tg, it is more preferable to not have a branched structure.

Here, the fact that the aliphatic hydrocarbon group having 6 or more carbon atoms as R¹ “does not have a branched structure” means that R¹ is a group in which one hydrogen atom is removed from a terminal carbon atom of a linear aliphatic hydrocarbon having 6 or more carbon atoms. For example, a 1-heptyl group is a group in which one hydrogen atom is removed from a terminal carbon atom of normal-heptane, and thus does not have a branched structure, whereas a 3-heptyl group is a group in which one hydrogen atom is removed from a carbon atom which is not located at the terminal of normal-heptane, and thus has a branched structure.

The number of carbon atoms in the aliphatic hydrocarbon group as R¹ is 6 or more, preferably 6 to 24, more preferably 6 to 22, still more preferably 6 to 18, particularly preferably 6 to 16, and among these, preferably 6 to 14 and more preferably 6 to 12.

In the aliphatic hydrocarbon group as R^{1,} the number of carbon atoms constituting a chain from a carbon atom having a bonding site to a carbon atom on the most terminal side, which is counted from a carbon atom to which R² is bonded, (hereinafter, referred to as “number of carbon atoms constituting the longest chain of R¹”) is preferably 5 or more and more preferably 6 or more. For example, in a structural unit (A-4) used in Examples, the number of carbon atoms constituting the longest chain of R¹ is 5.

R¹ is preferably an alkyl group, an alkenyl group, or an alkynyl group, each of which has 6 or more carbon atoms; more preferably an alkyl group or an alkenyl group, each of which has 6 or more carbon atoms; and still more preferably an alkyl group having 6 or more carbon atoms.

The aliphatic hydrocarbon group and the aromatic hydrocarbon group, which can be adopted as R², are not particularly limited, and the description of the aliphatic hydrocarbon group and aromatic hydrocarbon group above can be applied.

As the aliphatic hydrocarbon group which can be adopted as R², an alkyl group, an alkenyl group, or an alkynyl group is preferable, an alkyl group or an alkenyl group is more preferable, and an alkyl group is still more preferable.

It is preferable that R² does not include a ring structure. R² is preferably a hydrogen atom, an alkyl group, an alkenyl group, or an alkynyl group; more preferably a hydrogen atom or an alkyl group; still more preferably a hydrogen atom or an alkyl group having 1 to 6 carbon atoms; particularly preferably a hydrogen atom, a methyl group, or an ethyl group; and among these, a hydrogen atom or a methyl group is preferable.

### Structural Unit (B)

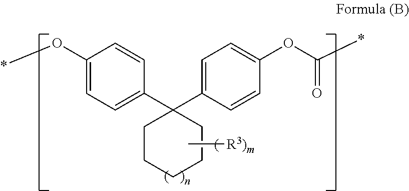

In the formula, R³ represents an aliphatic hydrocarbon group, n is an integer of 0 to 8, m is an integer of 4+n or less, and * represents a bonding site.

The aliphatic hydrocarbon group as R³ is not particularly limited, and the description of the aliphatic hydrocarbon group above can be applied.

As the aliphatic hydrocarbon group which can be adopted as R³, an alkyl group or an alkenyl group is preferable; an alkyl group is more preferable; an alkyl group having 1 to 6 carbon atoms is still more preferable; and an alkyl group having 1 to 4 carbon atoms is particularly preferable.

In a case where a plurality of R³'s are present, the plurality of R³'s may be the same or different from each other.

In a case where a plurality of R³'s are present, the plurality of R³'s may be bonded to each other to form a ring, but it is preferable that the plurality of R³'s do not form a ring.

n is an integer of 0 to 8, preferably an integer of 0 to 7, more preferably an integer of 0 to 4, and still more preferably 0 or 1.

m is an integer of 4+n or less, preferably an integer of 3+n or less and more preferably an integer of 2+n or less. Since the lower limit value of m is 0 or more, m is an integer of 0 to [4+n], preferably an integer of 0 to [3+n] and more preferably an integer of 0 to [2+n]. Among these, m is preferably an integer of 0 to 3.

### Structural Unit (C)

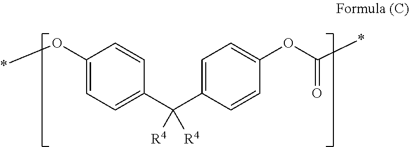

In the formula, R⁴ represents a hydrogen atom or an aliphatic hydrocarbon group having 1 to 5 carbon atoms, provided that R⁴'s are not bonded to each other to form a ring, and * represents a bonding site.

The aliphatic hydrocarbon group having 1 to 5 carbon atoms, which can be adopted as R^{4,} is not particularly limited as long as it has 1 to 5 carbon atoms, and an aliphatic hydrocarbon group having 1 to 5 carbon atoms among the above-described aliphatic hydrocarbon groups can be applied.

The number of carbon atoms in the aliphatic hydrocarbon group which can be adopted as R⁴ is 1 to 5, and from the viewpoint of low water absorbency, low dielectric constant, and low dielectric loss tangent, it is preferably 2 to 5.

The aliphatic hydrocarbon group having 1 to 5 carbon atoms, which can be adopted as R⁴, is preferably an alkyl group, an alkenyl group, or an alkynyl group, each of which has 1 to 5 carbon atoms; more preferably an alkyl group or an alkenyl group, each of which has 1 to 5 carbon atoms; and still more preferably an alkyl group having 1 to 5 carbon atoms.

R⁴ is preferably a hydrogen atom, or an alkyl group, an alkenyl group, or an alkynyl group, each of which has 1 to 5 carbon atoms; more preferably a hydrogen atom, or an alkyl group or an alkenyl group, each of which has 1 to 5 carbon atoms; and still more preferably a hydrogen atom or an alkyl group having 1 to 5 carbon atoms.

Two R⁴'s may be the same or different from each other.

At least one of R⁴'s is preferably an aliphatic hydrocarbon group having 1 to 5 carbon atoms, and from the viewpoint of low water absorbency, low dielectric constant, and low dielectric loss tangent, it is more preferably an aliphatic hydrocarbon group having 2 to 5 carbon atoms, still more preferably an alkyl group or an alkenyl group having 2 to 5 carbon atoms, and particularly preferably an alkyl group having 2 to 5 carbon atoms.

As a combination of two R⁴'s, it is preferable that one is an aliphatic hydrocarbon group having 2 to 5 carbon atoms and the other is a hydrogen atom or an aliphatic hydrocarbon group having 1 to 5 carbon atoms; it is more preferable that one is an aliphatic hydrocarbon group having 2 to 5 carbon atoms and the other is a hydrogen atom or an aliphatic hydrocarbon group having 1 to 3 carbon atoms; it is still more preferable that one is an aliphatic hydrocarbon group having 2 to 5 carbon atoms and the other is a hydrogen atom or an aliphatic hydrocarbon group having 1 or 2 carbon atoms; and it is particularly preferable that one is an aliphatic hydrocarbon group having 2 to 5 carbon atoms and the other is a hydrogen atom or an aliphatic hydrocarbon group having 1 carbon atom. In the combination of two R⁴'s, R⁴ as an aliphatic hydrocarbon group is preferably an alkyl group or an alkenyl group, and more preferably an alkyl group.

All 1,4-phenylene groups in General Formulae (A) to (C) may have the aliphatic hydrocarbon group and/or the aromatic hydrocarbon group described above as a substituent. In the present invention, a structure in which the 1,4-phenylene group shown in General Formulae (A) to (C) has an aliphatic hydrocarbon group and/or an aromatic hydrocarbon group as a substituent at a position other than the 1-position and the 4-position is also included in the structural unit represented by General Formulae (A) to (C).

The substituent which may be included in the 1,4-phenylene group in General Formulae (A) to (C) is preferably an aliphatic hydrocarbon group.

Among these, it is preferable that the 1,4-phenylene group in General Formulae (A) to (C) does not have a substituent, that is, the 1,4-phenylene group is an unsubstituted group.

Regarding specific examples of the structural units (A), (B), and (C) described above, each of carbonate structural units formed from specific examples of bisphenol compounds (a) to (c) described later can be referred to.

The proportion of the structural unit (A) in the total of 100 mol % of the structural units (A), (B), and (C) is 25 to 45 mol %, and from the viewpoint of low water absorbency, low dielectric constant, and low dielectric loss tangent, it is preferably 30 to 45 mol % and more preferably 35 to 45 mol %.

The proportion of the structural unit (B) in the total of 100 mol % of the structural units (A), (B), and (C) is 25 to 45 mol %, and from the viewpoint of further improving the impact resistance, it is preferably 25 to 40 mol %.

The proportion of the structural unit (C) in the total of 100 mol % of the structural units (A), (B), and (C) is 15 to 50 mol %, preferably 20 to 50 mol %, more preferably 20 to 45 mol %, and still more preferably 20 to 40 mol %.

The structural units (A), (B), and (C) contained in the polycarbonate according to the embodiment of the present invention may be each one kind or two or more kinds.

In a case where two or more kinds of the structural units (A) are present in the polycarbonate according to the embodiment of the present invention, the above-described proportion of the structural unit (A) means the total amount of the two or more kinds of the structural units (A). The same also applies to a case where two or more kinds of the structural units (B) are present and a case where two or more kinds of the structural units (C) are present.

### Other Structural Units

The polycarbonate according to the embodiment of the present invention may contain a structural unit other than the above-described structural units (A), (B), and (C) (hereinafter, referred to as “other structural units”).

The other structural units are not particularly limited as long as the effect of the present invention is exhibited, and examples thereof include a carbonate structural unit derived from a bisphenol compound, which is a structural unit different from all of the above-described structural units (A), (B), and (C). Specific examples thereof include a structural unit different from all of the above-described structural units (A), (B), and (C), among carbonate structural units derived from a bisphenol compound represented by General Formula (II′) of WO2007/119548A.

It is sufficient that a proportion of the above-described=structural units (A), (B), and (C) (the total amount of the structural units (A) to (C)) in all structural units constituting the polycarbonate according to the embodiment of the present invention is, for example, 90 mol % or more; and the proportion is preferably 93 mol % or more, more preferably 95 mol % or more, and still more preferably 97 mol % or more. The upper limit value thereof is not limited, and it is also preferable that all structural units contained in the polycarbonate according to the embodiment of the present invention are composed of any of the above-described structural units (A) to (C).

Each structural unit constituting the polycarbonate according to the embodiment of the present invention may be randomly bonded or may be bonded in a block shape. The polycarbonate according to the embodiment of the present invention is preferably a random copolymer.

From the viewpoint of heat resistance of a molded product containing the polycarbonate resin according to the embodiment of the present invention, Tg of the polycarbonate according to the embodiment of the present invention can be 100° C. or higher, and it is preferably 110° C. or higher and more preferably 120° C. or higher. The upper limit value thereof is not particularly limited, but is practically 200° C. or lower. That is, the Tg of the polycarbonate according to the embodiment of the present invention can be 100° C. to 200° C., and it is preferably 110° C. to 200° C. and more preferably 120° C. to 200° C.

In the present invention, the Tg of the polycarbonate is a value measured by a method described in Examples later.

From the viewpoint of impact resistance, an impact strength of the polycarbonate according to the embodiment of the present invention can be 8 KJ/cm² or more, and it is preferably 10 KJ/cm² or more and more preferably 20 KJ/cm² or more. The upper limit value thereof is not particularly limited, but is practically 50 KJ/cm² or less. That is, the impact strength of the polycarbonate according to the embodiment of the present invention can be 8 to 50 KJ/cm², and it is preferably 10 to 50 KJ/cm² and more preferably 20 to 50 KJ/cm².

In the present invention, the impact strength of the polycarbonate is measured by a method described in Examples later. That is, the impact strength of the polycarbonate is a notched Charpy impact strength measured in accordance with Japanese Industrial Standards (JIS) K7111-1 (2012).

A water absorption rate of the polycarbonate according to the embodiment of the present invention can be less than 0.30% by mass, and it is preferably less than 0.25% by mass and more preferably less than 0.20% by mass. The lower limit value thereof is not particularly limited.

In the present invention, the water absorption rate of the polycarbonate is a water absorption rate measured and calculated by Karl Fischer vaporization method described in Examples later.

The polycarbonate according to the embodiment of the present invention has low water absorbency and thus can be suitably used as a low dielectric material.

A dielectric constant (relative permittivity) of the polycarbonate according to the embodiment of the present invention at 25° C. and 10 GHz can be less than 2.9, and it is preferably less than 2.8 and more preferably less than 2.7. The lower limit value thereof is not particularly limited, but is practically 2.0 or more.

In addition, a dielectric loss tangent of the polycarbonate according to the embodiment of the present invention at 25° C. and 10 GHz can be less than 0.045, and it is preferably less than 0.040 and more preferably less than 0.035. The lower limit value thereof is not particularly limited, but is practically 0.010 or more.

In the present invention, the dielectric constant and the dielectric loss tangent of the polycarbonate at 25° C. and 10 GHz are values measured by a resonance perturbation method described in Examples later.

From the viewpoint of excellent fluidity and viewpoint of obtaining a molded product having a small thickness and excellent formability, a melt volume-flow rate (MVR) of the polycarbonate according to the embodiment of the present invention is usually preferably 20 ml/10 min or more. The upper limit value thereof is not particularly limited, but is practically less than 60 ml/10 min.

In the present invention, the MVR of the polycarbonate is a value measured by a method described in Examples later.

A weight-average molecular weight (Mw) of the polycarbonate according to the embodiment of the present invention may be appropriately adjusted according to the chemical structures of the above-described structural units (A) to (C) and the content proportions thereof so as to exhibit MVR capable of achieving favorable formability. For example, the weight-average molecular weight of the polycarbonate according to the embodiment of the present invention can be 10,000 to 200,000, and it is preferably 20,000 to 150,000, more preferably 30,000 to 120,000, and still more preferably 40,000 to 100,000. The weight-average molecular weight can be adjusted by adjusting an equivalent ratio of phosgene or a carbonic acid ester compound to be reacted with the bisphenol compound.

In the present invention, the weight-average molecular weight of the polycarbonate is a value measured by a method described in Examples later.

### Synthesis Method

The polycarbonate according to the embodiment of the present invention can be produced by a conventional method, and for example, the polycarbonate can be produced by adopting a polycondensation reaction of a diol compound and phosgene (phosgene method or pyridine method) or an ester exchange reaction of a diol compound and a carbonic ester compound (ester exchange method).

### Diol Compound

In any of the phosgene method, the pyridine method, or the ester exchange method, at least a bisphenol compound (a) represented by Formula (a), a bisphenol compound (b) represented by Formula (b), and a bisphenol compound (c) represented by Formula (c), which are necessary for synthesizing the above-described structural units (A) to (C), are used as the diol compound.

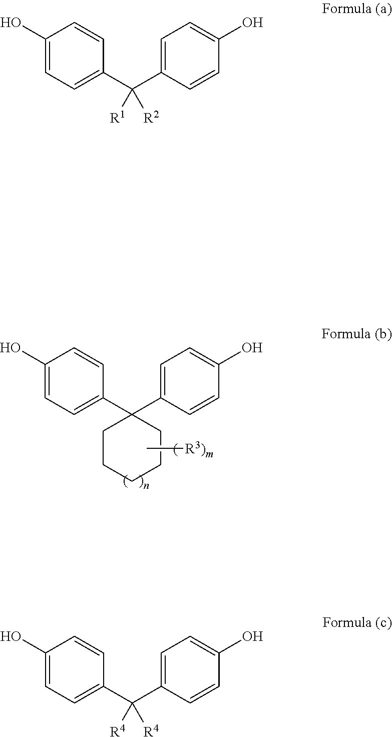

R¹ to R⁴, m, and n in Formulae (a) to (c) correspond to and have the same definitions as R¹ to R⁴, m, and n in Formulae (A) to (C) described above, respectively.

Preferred specific examples of the above-described bisphenol compounds (a) to (c) are described below, but the present invention is not limited to an aspect in which these compounds are used.

### Bisphenol Compound (a)

Examples of the bisphenol compound (a) in which R¹ is a nonyl group and R² is a hydrogen atom include 1,1-bis(4-hydroxyphenyl)decane, 1,1-bis(3-methyl-4-hydroxyphenyl)decane, 1,1-bis(2,3-dimethyl-4-hydroxyphenyl)decane, 1,1-bis(3,5-dimethyl-4-hydroxyphenyl)decane, 1,1-bis(3-ethyl-4-hydroxyphenyl)decane, 1,1-bis(3-propyl-4-hydroxyphenyl)decane, 1,1-bis(3-butyl-4-hydroxyphenyl)decane, and 1,1-bis(3-nonyl-4-hydroxyphenyl)decane.

Specific examples thereof also include compounds in which R¹ and/or R² in the above-described compound is replaced with R¹ and/or R² in General Formula (A) described above.

### Bisphenol Compound (b)

Examples of the bisphenol compound (b) in which n is 1, m is 3, and R³ is a methyl group include 1,1-bis(4-hydroxyphenyl)-3,3,5-trimethylcyclohexane, 1,1-bis(3-methyl-4-hydroxyphenyl)-3,3,5-trimethylcyclohexane, and 1,1-bis(3-phenyl-4-hydroxyphenyl)-3,3,5-trimethylcyclohexane.

Specific examples thereof also include compounds in which at least any of n, m, and R³ in the above-described compound is replaced with n, m, and R³ in General Formula (B) described above.

### Bisphenol Compound (c)

Examples of the bisphenol compound (c) in which one R⁴ is a hydrogen atom and the other R⁴ is an ethyl group include 1,1-bis(4-hydroxyphenyl)propane, 1,1-bis(3-methyl-4-hydroxyphenyl)propane, 1,1-bis(2,3-dimethyl-4-hydroxyphenyl)propane, 1,1-bis(3,5-dimethyl-4-hydroxyphenyl)propane, 1,1-bis(3-ethyl-4-hydroxyphenyl)propane, 1,1-bis(3-propyl-4-hydroxyphenyl)propane, 1,1-bis(3-butyl-4-hydroxyphenyl)propane, and 1,1-bis(3-nonyl-4-hydroxyphenyl)propane.

Specific examples thereof also include compounds in which at least one of R⁴'s in the above-described compound is replaced with R⁴ in General Formula (C) described above.

In a case where the polycarbonate according to the embodiment of the present invention contains a structural unit other than the above-described structural units (A), (B), and (C) (other structural units), a diol compound corresponding to the other structural units is used in addition to the above-described bisphenol compounds (a) to (c).

Specific examples thereof include a structural unit different from all of the above-described bisphenol compounds (a), (b), and (c), among bisphenol compounds represented by General Formula (II') of WO2007/119548A.

In the phosgene method or the pyridine method, the diol compound and the phosgene are usually reacted with each other in the presence of an acid bonding agent such as pyridine and an organic solvent such as dichloromethane. The synthesis of the polycarbonate according to the embodiment of the present invention by the phosgene method or the pyridine method can be carried out by a conventional method, and for example, a phosgene method described in paragraphs [0072] to [0074] of WO2007/119548A, an interfacial polymerization method described in paragraphs [0035] to [0046] of JP2005-263886A, an interfacial polymerization method described in paragraphs [0021] to [0028] and [0036] of WO2017/099226A, and a pyridine method described in Polycarbonate Resin Handbook (NIKKAN KOGYO SHIMBUN, LTD.) can be referred to.

With regard to the phosgene to be reacted with the diol compound, a method in which phosgene itself is used as a raw material may be adopted, or a method in which diphosgene or triphosgene is used as a raw material and the phosgene is generated in a reaction system by a reaction with a Lewis base such as pyridine may be adopted.

The synthesis of the polycarbonate according to the embodiment of the present invention by the ester exchange method can be carried out by a conventional method, and for example, an ester exchange method described in paragraphs [0075] and [0076] of WO2007/119548A, a melt polymerization method described in paragraphs [0029] to [0035] of JP2005-263886A, and a melt ester exchange method described in paragraphs [0029] to [0035] and [0037] to [0038] of WO2017/099226A can be referred to.

### Additive

The polycarbonate resin according to the embodiment of the present invention may be configured by blending an additive into the polycarbonate according to the embodiment of the present invention.

As the additive, a commonly used additive as an additive to a polycarbonate resin can be used as long as the effect of the present invention is not impaired; and examples thereof include polyalkylene glycol or a fatty acid ester (C) thereof, a heat stabilizer (D), and a phenolic antioxidant, which are described in paragraphs [0073] to [0087] of WO2017/099226A.

In addition, depending on various applications, a flame retardant, a mold release agent, an ultraviolet absorber, a dye, a pigment, a fluorescent brightener, a dripping inhibitor, an antistatic agent, an anti-fogging agent, a lubricant, an antiblocking agent, a dispersing agent, an antibacterial agent, or the like can be used.

### Application

The polycarbonate resin according to the embodiment of the present invention can be used without particular limitation in applications in which a polycarbonate resin is used; and examples thereof include automobile parts such as a meter plate, a headlamp lens, a door handle, a sunroof, an instrument panel, and a wheel cover, electrical or electronic components such as a mobile phone housing, a memory stick, a compact disc (CD), a magneto-optical disc (MO), a digital versatile disk (DVD), a Blu-ray (registered trademark) disc (BD), and a high-definition digital versatile disc (HD-DVD), a digital camera housing, a printer chassis, a personal computer housing, optical components such as a camera lens, an aspherical lens, a prism, a light guide, glasses, sunglasses, goggles, protective glasses, a dome roof, and window glass, medical equipment such as an artificial organ for medical use, and other examples such as a helmet, a baby bottle, a tableware, a stationery, and a greenhouse. In addition, the polycarbonate resin according to the embodiment of the present invention is used as a light guide plate and a member for a surface light emitter, as a component of a device or an instrument which directly or indirectly uses a light source such as a light-emitting diode (LED), an organic electro-luminescence (EL), an incandescent light bulb, a fluorescent lamp, or a cathode tube. The light guide plate can be suitably used in fields of a liquid crystal backlight unit, various display devices, and an illumination device. Examples of such a device include various portable terminals such as a mobile phone, a mobile notebook, a netbook, a slate personal computer (PC), a tablet PC, a smartphone, and a tablet type terminal; a camera, a watch, a notebook computer, various displays, and a lighting device.

The polycarbonate resin according to the embodiment of the present invention exhibits low water absorbency while achieving both high Tg and excellent impact resistance, and thus can be suitably used as a low dielectric material requiring a low dielectric constant and a low dielectric loss tangent.

### Molded Product

The molded product according to the embodiment of the present invention contains the polycarbonate resin according to the embodiment of the present invention.

A molding method using the polycarbonate resin according to the embodiment of the present invention is not particularly limited, and in addition to a molding method used for a thermoplastic resin, such as injection molding, extrusion molding, vacuum molding, and blow molding, a thermal fusion laminating method in which a representative resin in a method for manufacturing a 3D printer is melted and laminated can also be applied.

In addition, the polycarbonate resin according to the embodiment of the present invention can achieve the high Tg, low water absorbency, and excellent impact resistance even in a case where the polycarbonate resin has an MVR (usually, approximately 20 ml/10 min or more and less than 60 ml/10 min) at which favorable formability is obtained, and thus the polycarbonate resin is suitably used for molding a thin optical component. Specifically, pellets obtained by pelletizing the polycarbonate resin according to the embodiment of the present invention can be molded by various molding methods to manufacture a thin optical component, and is particularly suitably used for molding a thin optical component by an injection molding method.

Regarding the definition and the forming method of the thin optical component, in the description of paragraphs [0095] to [0097] of WO2017/099226A, “polycarbonate resin composition” is replaced with “polycarbonate resin according to the embodiment of the present invention”, and the description is applied to the present specification.

### EXAMPLES

Hereinafter, the present invention will be described in more detail with reference to Examples. The materials, amounts used, proportions, treatment contents, treatment procedures, and the like shown in the following examples can be modified as appropriate in the range of not departing from the spirit of the present invention. Therefore, the scope of the present invention should not be construed as being limited to the following specific examples.

### Synthesis Example of Polycarbonate

### (1) Synthesis of Polycarbonate 14

45 g (127 mol) of 4,4′-dodecylidene bisphenol (manufactured by Honshu Chemical Industry Co., Ltd.), 29.5 g (95 mol) of 4,4′-(3,3,5-trimethyl-1,1-cyclohexanediyl) bisphenol (manufactured by Honshu Chemical Industry Co., Ltd.), 25.5 g (94 mol) of 4,4′-(4-methylpentane-2,2-diyl) bisphenol (manufactured by Honshu Chemical Industry Co., Ltd.), and 385 ml of dichloromethane (ultra-dehydrated) (manufactured by FUJIFILM Wako Pure Chemical Corporation) were added to a 1 L three-neck flask equipped with a reflux condenser and a gas introduction coke. Nitrogen gas was introduced at a flow rate of 20 mL/min, 61.1 g of pyridine (ultra-dehydrated) (manufactured by FUJIFILM Wako Pure Chemical Corporation) was added thereto, and the mixture was cooled with ice until the internal temperature reached 5° C. A solution obtained by dissolving 34.2 g of triphosgene (manufactured by FUJIFILM Wako Pure Chemical Corporation) in 257 ml of dichloromethane (ultra-dehydrated) (manufactured by FUJIFILM Wako Pure Chemical Corporation) was added dropwise thereto such that an internal temperature of the reaction solution was maintained at 10° C. or lower, and the mixture was stirred at 25° C. for 2 hours after the completion of the dropwise addition. 455 ml of 0.5 N hydrochloric acid water was added to the reaction solution, and the mixture was stirred for 30 minutes, and then subjected to a liquid separation operation with deionized water three times. The obtained dichloromethane solution was added dropwise to 500 ml of isopropanol (manufactured by FUJIFILM Wako Pure Chemical Corporation) while being stirred to obtain a polycarbonate 14. A dry yield amount was 90 g (yield: 90%), a weight-average molecular weight was 50,000, and a MVR was 23 ml/10 min.

### (2) Synthesis of Polycarbonates 1 to 13, 15 to 17, and c01 to c10

A polycarbonate shown in Table 1 later was synthesized in the same manner as the synthesis of the polycarbonate 14 described above, using monomer components described in the columns of the structural units (A) to (C). The polycarbonate described in Table 1 was prepared and synthesized by adjusting the equivalent ratio of triphosgene to the bisphenol compound so that the MVR of the polycarbonate was a value in a range of 20 ml/10 min or more and less than 30 ml/10 min, which exhibited favorable formability.

The MVR was measured by an isothermal method under the following conditions, using a flow tester CFT-500D (product name, manufactured by Shimadzu Corporation) for a dried sample of the synthesized polycarbonate.

### Measurement Condition

Measurement temperature: 300° C.

Retained heat time: 300 seconds

Test force: 6 Kgf/cm²

Die hole diameter: φ1 mm

Polycarbonates 1 to 17 are the polycarbonate according to the embodiment of the present invention, and polycarbonates c01 to c10 are polycarbonates for comparison.

### Evaluation

The obtained polycarbonate was subjected to the following measurement and evaluation. The results are summarized in Table 1 later.

### Evaluation 1: Evaluation of Water Absorbency

A uniform film of the polycarbonate, having a thickness of approximately 0.5 mm, was produced by a heat press (approximately 240° C. to 280° C.), and approximately 0.2 g of a sample was cut out from the produced film and infused with deionized water. After infusing the film at 25° C. for one week to prepare a saturated water-containing sample, water droplets on the surface were wiped off, the sample was subjected to a measurement by a Karl Fischer vaporization method (measurement device: AQ-2250 (product name, manufactured by Kitahama Corporation), vaporization device: AQS-225320 (product name, manufactured by Hiranuma Co., Ltd.), reagent used: AQUALITE RS-A (for general use, product name, manufactured by Hiranuma Co., Ltd.), measurement temperature: 180° C., nitrogen gas flow rate: 200 ml/min), and a water absorption rate calculated from the following expression was applied to the following standard to evaluate water absorbency.

Water absorption rate (% by mass)=100%×(C−D)/E

C represents the amount of water measured in the saturated moisture-containing sample, D represents the amount of water measured in the Blank, and E represents the sampling amount of the saturated moisture-containing sample used for the measurement.

### Evaluation Standard

5: less than 0.20% by mass

4: 0.20% by mass or more and less than 0.25% by mass

3: 0.25% by mass or more and less than 0.30% by mass

2: 0.30% by mass or more and less than 0.35% by mass

1: 0.35% by mass or more

### Evaluation 2: Evaluation of Glass Transition Temperature (Tg)

As a glass transition temperature (Tg) of the polycarbonate, the glass transition temperature described in Tables of POLYMER HANDBOOK 4th, Chapter 36 was adopted. In a case where the glass transition temperature is not described in the above-described reference, the glass transition temperature was a value measured under the following measurement conditions. The Tg was evaluated according to the following standard.

### Measurement of Tg

The glass transition temperature (Tg) was measured under the following measurement conditions for a dried sample of the polycarbonate using a differential scanning calorimeter: X-DSC7000 (product name, manufactured by SII NanoTechnology Inc.). Tg was measured twice for the same sample, and the secondly measurement result was adopted.

### Measurement Condition

Atmosphere in measurement chamber: nitrogen gas (50 ml/min)

Temperature increase rate: 5° C./min

Measurement start temperature: −80° C.

Measurement end temperature: 250° C.

Specimen pan: aluminum pan

Mass of measurement sample: 5 mg

Calculation of Tg: Tg was calculated by rounding off the decimal point in the intermediate temperature between the descent start point and the descent end point of the differential scanning calorimetry (DSC) chart.

### Evaluation Standard

5: 120° C. or higher and 200° C. or lower

4: 110° C. or higher and lower than 120° C.

3: 100° C. or higher and lower than 110° C.

2: 80° C. or higher and lower than 100° C.

1: lower than 80° C.

### Evaluation 3: Evaluation of Impact Resistance

According to the Japanese Industrial Standards (JIS) K7111-1 (2012), a Charpy impact test of a notched test piece was carried out using a notched test piece of polycarbonate directly molded in a notch shape A, and the calculated notched Charpy impact strength was applied to the following standard to evaluate impact resistance.

### Measurement Condition

Test device: Charpy impact tester (manufactured by Toyo Seiki Co., Ltd.)

Hammer: 1.0 J

Temperature: 25° C.

### Evaluation Standard

5: 20 KJ/cm² or more and 50 KJ/cm² or less

4: 10 KJ/cm² or more and less than 20 KJ/cm²

3: 8 KJ/cm² or more and less than 10 KJ/cm²

2: 5 KJ/cm² or more and less than 8 KJ/cm²

1: less than 5 KJ/cm²

### Evaluation 4: Evaluation of Dielectric Constant and Dielectric Loss Tangent

The dielectric loss tangent was measured by a resonance perturbation method at a frequency of 10 GHz. A 10 GHz cavity resonator (manufactured by Kanto Electronic Application Development Inc., product name: CP531) was connected to a network analyzer (manufactured by Agilent Technology, Inc., product name: E8363B), and a film-like test piece cut out from the uniform film produced in Evaluation 1 described above was inserted into the cavity resonator, and the film-like test piece was left to stand in an environment of a temperature of 25° C. and an RH of 60% for 96 hours. A dielectric constant and a dielectric loss tangent of the film were measured from a change in resonance frequency between before inserting the test piece and after inserting the test piece and then leaving it to stand for 96 hours, and evaluated by applying the following standard.

Evaluation Standard (Dielectric Constant) 5: 2.0 or more and less than 2.7

4: 2.7 or more and less than 2.8

3: 2.8 or more and less than 2.9

2: 2.9 or more and less than 3.0

1: 3.0 or more

### Evaluation Standard (Dielectric Loss Tangent)

5 :0.010 or more and less than 0.035

4: 0.035 or more and less than 0.040

3: 0.040 or more and less than 0.045

2: 0.045 or more and less than 0.050

1: 0.050 or more

### Evaluation 5: Measurement Of Weight-Average Molecular Weight

A weight-average molecular weight (Mw) of the polycarbonate was measured in terms of polystyrene by gel permeation chromatography (GPC) under the following measurement condition 1.

### Measurement Condition 1

Measuring instrument: TOSOH EcoSEC HLC-8320GPC (product name, manufactured by Tosoh Corporation)

Column: connection of TOSOH TSKgel Super HZM-H (product name, manufactured by Tosoh Corporation), TOSOH TSKgel Super HZ4000 (product name, manufactured by Tosoh Corporation), and TOSOH TSKgel Super HZ2000 (product name, manufactured by Tosoh Corporation)

Carrier: tetrahydrofuran (containing a BHT stabilizer) (manufactured by FUJIFILM Wako Pure Chemical Corporation)

Measurement temperature: 40° C.

Carrier flow rate: 0.35 ml/min

Sample Concentration: 0.05% by mass

Detector: refractive index (RI) detector, UV detector (254 nm)

TABLE 1

| | Structural unit (A) | | Structural unit (B) | | Structural unit (C) | | | | | | | |
|---|---|---|---|---|---|---|---|---|---|---|---|---|
| | Monomer | Molar | Monomer | Molar | Monomer | Molar | | Water | Dielectric | Dielectric | | Impact |
| No. | component | ratio | component | ratio | component | ratio | Mw | absorbency | constant | loss tangent | Tg | resistance |
| 1 | A-1 | 40 | B-1 | 30 | C-1 | 30 | 45000 | 4 | 4 | 4 | 4 | 5 |
| 2 | A-2 | 40 | B-2 | 30 | C-2 | 30 | 43000 | 4 | 4 | 4 | 4 | 5 |
| 3 | A-3 | 40 | B-3 | 30 | C-3 | 30 | 48000 | 4 | 4 | 4 | 4 | 5 |
| 4 | A-4 | 40 | B-4 | 30 | C-4 | 30 | 65000 | 5 | 5 | 5 | 3 | 4 |
| 5 | A-5 | 40 | B-4 | 30 | C-4 | 30 | 58000 | 5 | 5 | 5 | 4 | 4 |
| 6 | A-5 | 40 | B-5 | 30 | C-5 | 30 | 52000 | 5 | 5 | 5 | 4 | 4 |
| 7 | A-6 | 40 | B-6 | 30 | C-6 | 30 | 45000 | 5 | 5 | 5 | 4 | 5 |
| 8 | A-7 | 40 | B-1 | 30 | C-7 | 30 | 48000 | 5 | 5 | 5 | 4 | 5 |
| 9 | A-4 | 40 | B-2 | 30 | C-8 | 30 | 63000 | 5 | 5 | 5 | 4 | 4 |
| 10 | A-3 | 40 | B-3 | 30 | C-9 | 30 | 54000 | 5 | 5 | 5 | 4 | 5 |
| 11 | A-2 | 40 | B-4 | 40 | C-10 | 20 | 60000 | 5 | 5 | 5 | 4 | 4 |
| 12 | A-1 | 30 | B-2 | 40 | C-11 | 30 | 56000 | 4 | 4 | 4 | 4 | 5 |
| 13 | A-3 | 40 | B-2 | 30 | C-1 | 30 | 45000 | 4 | 4 | 4 | 4 | 5 |
| 14 | A-3 | 40 | B-4 | 30 | C-10 | 30 | 50000 | 5 | 5 | 5 | 4 | 4 |
| 15 | A-3 | 25 | B-4 | 25 | C-10 | 50 | 55000 | 3 | 3 | 3 | 4 | 5 |
| 16 | A-3 | 25 | B-4 | 45 | C-10 | 30 | 42000 | 3 | 3 | 3 | 5 | 3 |
| 17 | A-3 | 40 | B-4 | 45 | C-10 | 15 | 55000 | 5 | 5 | 5 | 4 | 3 |
| c01 | A-3 | 50 | B-4 | 45 | C-10 | 5 | 57000 | 5 | 5 | 5 | 2 | 3 |
| c02 | A-3 | 45 | B-4 | 50 | C-10 | 5 | 48000 | 5 | 5 | 5 | 4 | 2 |
| c03 | A-3 | 50 | — | — | C-10 | 50 | 73000 | 5 | 5 | 5 | 1 | 5 |
| c04 | A-3 | 40 | B-4 | 20 | C-10 | 40 | 65000 | 5 | 5 | 5 | 2 | 5 |
| c05 | A-3 | 30 | B-4 | 20 | C-10 | 50 | 68000 | 4 | 4 | 4 | 2 | 5 |
| c06 | A-3 | 20 | B-4 | 30 | C-10 | 50 | 48000 | 2 | 2 | 2 | 5 | 5 |
| c07 | A-3 | 20 | B-4 | 20 | C-10 | 60 | 52000 | 2 | 2 | 2 | 4 | 5 |
| c08 | A-2 | 20 | B-2 | 50 | C-3 | 30 | 40000 | 2 | 2 | 2 | 5 | 2 |
| c09 | A-3 | 50 | B-4 | 25 | C-10 | 25 | 72000 | 5 | 5 | 5 | 2 | 5 |
| c10 | A-3 | 25 | B-4 | 50 | C-10 | 25 | 43000 | 3 | 3 | 3 | 5 | 2 |

(Note to table)
No. 1 to 17 and c01 to c10 respectively indicates polycarbonates 1 to 17 and c01 to c10.
The monomer components described in the columns of the structural units (A) to (C) are as follows.

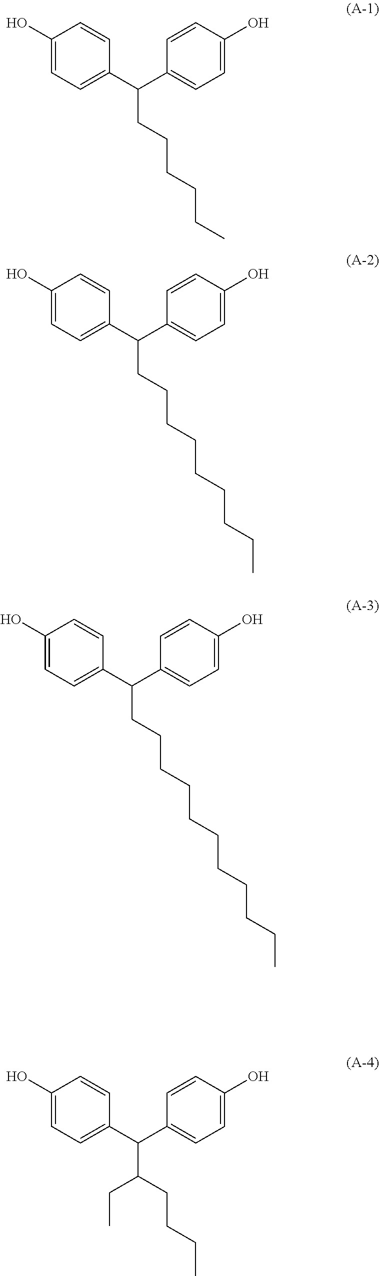

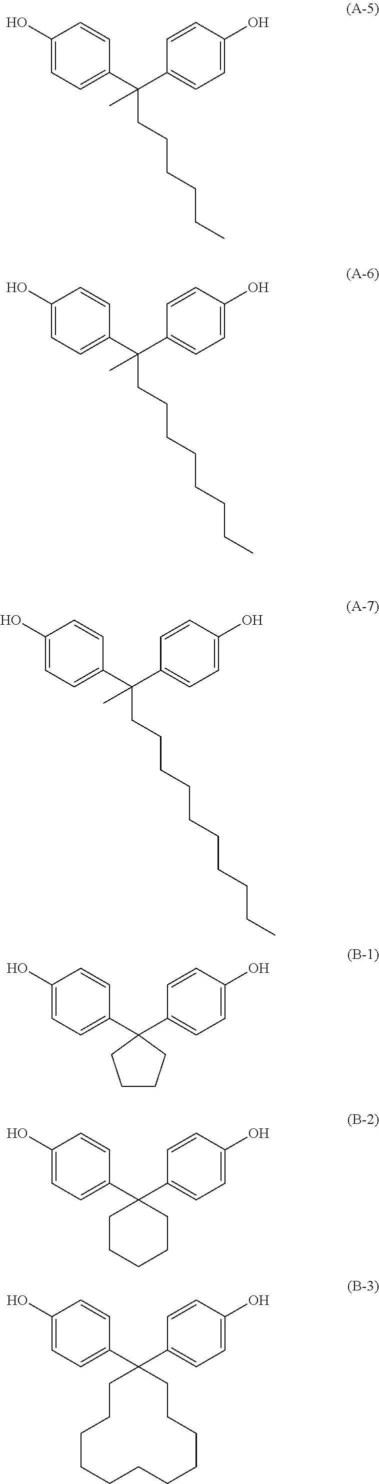

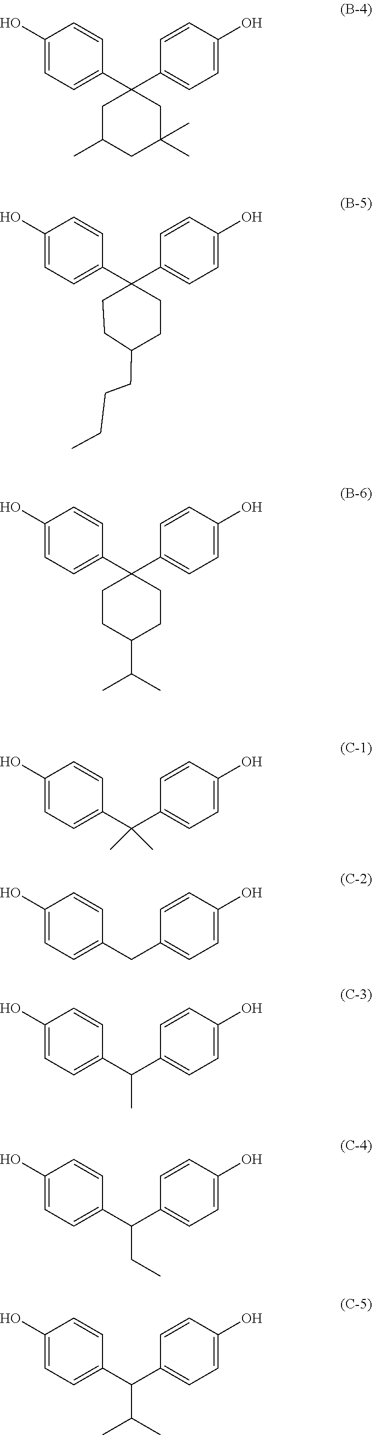

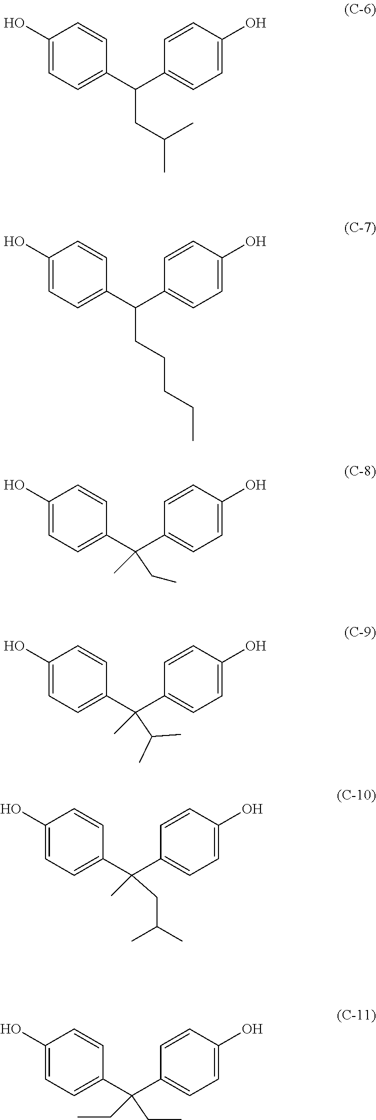

The molar ratios of the structural units (A) to (C) respectively indicate the proportions of the respective structural units in the total of 100 mol % of the structural units (A) to (C) obtained from the respective monomer components described in the columns of the structural units (A) to (C) and triphosgene, in which the unit is mol %.
“-” in the column of No. c03 indicates that the corresponding structural unit was not contained.

As shown in Table 1, the polycarbonates c01 to c10 not satisfying the definition of the present invention could not achieve all of high Tg, low water absorbency, and impact resistance. It was found that, in the polycarbonates c06 to c08 in which the content proportion of the structural unit (A) was as low as 20 mol %, the water absorption rate was as high as 0.30% by mass or more, and even in a case where the ratio of the structural units (B) and (C) was adjusted, the low water absorbency could not be achieved. On the contrary, it was found that, in all of the polycarbonates c01, c03, and c09 in which the content proportion of the structural unit (A) was as high as 50 mol %, the Tg was low at lower than 100° C., and it was difficult to achieve both high Tg and impact resistance while satisfying low water absorbency by adjusting the ratio of the structural units (B) and (C). In addition, it was found that, in the polycarbonates c02, c04, c05, and c10 in which the content proportion of the structural unit (A) was within the range of 25% to 45 mol % defined in the present invention, but at least one of the content proportions of the structural units (B) and (C) was outside the range defined in the present invention, the Tg was low at lower than 100° C., or the impact strength was low as less than 8 kJ/cm², and it was difficult to achieve both high Tg and impact resistance while satisfying low water absorbency.

In contrast, it was found that all of the polycarbonates 1 to 17 satisfying the definition of the present invention achieved all of the high Tg, the low water absorbency, and the impact resistance. Furthermore, it was found that, with the low water absorbency, it was possible to exhibit a low dielectric constant and a low dielectric loss tangent, and thus the polycarbonate could be suitably used as a low dielectric material. In particular, from the comparison between the polycarbonates 14 to 17 in which the structures of the structural units (A) to (C) were aligned and the content proportions of the respective structural units were changed, it was found that, in a case where the proportion of the structural unit (A) was 30 to 45 mol %, it was possible to achieve more excellent low water absorbency, low dielectric constant, and low dielectric loss tangent; and in a case where the proportion of the structural unit (B) was 25 to 40 mol %, it was possible to achieve more excellent impact resistance. In addition, from the comparison between the polycarbonates 3 and 10 in which only the structure of the structural unit (C) was different, it was found that, in a case where at least one of R⁴'s in General Formula (C) was an aliphatic hydrocarbon group having 2 to 5 carbon atoms, it was possible to achieve more excellent low water absorbency, low dielectric constant, and low dielectric loss tangent. In addition, from the comparison between the polycarbonates 4 and 5 in which only the structure of the structural unit (A) was different, it was found that, in a case where R¹ in General Formula (A) was an aliphatic hydrocarbon group having 6 or more carbon atoms, which did not have a branched structure, a higher Tg could be achieved.

The present invention has been described with the embodiments thereof, any details of the description of the present invention are not limited unless described otherwise, and it is obvious that the present invention is widely construed without departing from the gist and scope of the present invention described in the accompanying claims.

What is claimed is:

1. A polycarbonate resin comprising:
a structural unit (A) represented by General Formula (A);
a structural unit (B) represented by General Formula (B); and
a structural unit (C) represented by General Formula (C),
wherein, with respect to a total of 100 mol % of the structural units (A), (B), and (C), a proportion of the structural unit (A) is 25 to 45 mol %, a proportion of the structural unit (B) is 25 to 45 mol %, and a proportion of the structural unit (C) is 15 to 50 mol %, 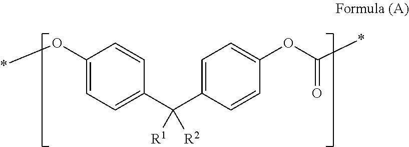
in the formula, R¹ represents an aliphatic hydrocarbon group having 6 or more carbon atoms, and R² represents a hydrogen atom, an aliphatic hydrocarbon group, or an aromatic hydrocarbon group, provided that R¹ and R² are not bonded to each other to form a ring, and * represents a bonding site, 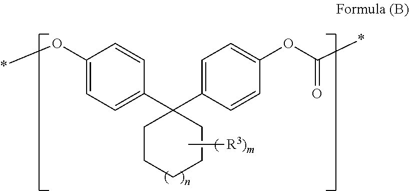
in the formula, R³ represents an aliphatic hydrocarbon group, n is an integer of 0 to 8, m is an integer of 4+n or less, and * represents a bonding site, 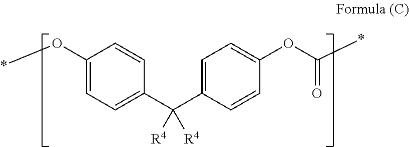
in the formula, R⁴ represents a hydrogen atom or an aliphatic hydrocarbon group having 1 to 5 carbon atoms, provided that R⁴'s are not bonded to each other to form a ring, and * represents a bonding site,
a 1,4-phenylene group in General Formulae (A) to (C) may have an aliphatic hydrocarbon group and/or an aromatic hydrocarbon group as a substituent.

2. The polycarbonate resin according to claim 1,
wherein the proportion of the structural unit (A) is 30 to 45 mol %.

3. The polycarbonate resin according to claim 1,
wherein the proportion of the structural unit (B) is 25 to 40 mol %.

4. The polycarbonate resin according to claim 1,
wherein, in General Formula (C), at least one of R⁴'s is an aliphatic hydrocarbon group having 2 to 5 carbon atoms.

5. The polycarbonate resin according to claim 1,
wherein, in General Formula (A), R¹ has no branched structure.

6. A molded product comprising:
the polycarbonate resin according to claim 1.
